(19) United States
(12) Patent Application Publication
(10) Pub. No.: US 2009/0259583 A1
(43) Pub. Date: Oct. 15, 2009

(54) Method And Apparatus For Making Markets For An electronically Traded Financial Instrument

(75) Inventor: Braden S. Janowski, Tulsa, OK (US)

Correspondence Address: TRADEHELM, INC., 5727 S. LEWIS AVE, STE. 500, TULSA, OK, 74105, US

(73) Assignee: TradeHelm, Inc., Tulsa, OK (US)

(21) Appl. No.: 12/103,615

(22) Filed: Apr. 15, 2008

(51) Int. Cl. G06Q 40/00

(52) U.S. Cl. 705/37

(57) ABSTRACT

A method and apparatus enables quick and efficient adjustment of parameters of a strategy for making markets in a financial instrument traded on an electronic exchange. Implemented in software, the market making adjustment apparatus and method employs a user GUI (Graphical User Interface) with areas of the GUI configured for adjusting market making parameters such as Book Depth, Aggression and Bias. The user is able to map the adjustment areas of the GUI to specific levels of parameter adjustment.

### FIELD OF THE INVENTION

The invention relates in general to making markets for electronically traded financial instruments. More particularly, the invention relates to a method and apparatus that enables a trader to efficiently adjust parameters of resting Bid and Ask orders that were submitted accordingly to a market making strategy.

### BACKGROUND OF THE INVENTION

As electronic trading of financial instruments has evolved, so too has the way in which market makers operate. A market maker can be defined loosely as one who maintains buy (Bid) and sell (Ask) prices in a given instrument by standing ready, willing and able to buy or sell lots/shares at publicly quoted prices. The difference between the price at which a market maker is willing to buy a financial instrument and the price at which the market maker is willing to sell it is called the Bid/Ask spread, or “turn”. The market maker quotes both Bid and Ask prices in the financial instrument, hoping to make a profit on the turn. Market makers must give traders the best Bid or Ask price for each market order transaction. This ensures a fair and reasonable two-sided market. Market makers compete among themselves for customer order flows by displaying buy and sell quotations for a guaranteed number of shares. Once an order is received, the market maker immediately sells from its own inventory or seeks an offsetting order. The number of market makers for a given instrument can vary greatly, depending on the average daily volume for the particular instrument. The market makers play an important role in the secondary market as catalysts, particularly for enhancing stock liquidity and, therefore, for promoting long-term growth in the market.

Market makers often employ proprietary strategies to determine the parameters (such as a Bid/Ask spread and book depth) of the Bids and Asks that it submits to an electronic exchange. For example, the market maker may determine that it should make markets in a particular financial instrument by placing Bids at one price level that is two tick intervals below the current market value and to place Asks at one price level that is two tick intervals above the current market value. Since the Bid/Ask spread generally represents the market maker's profit, the market maker has an incentive to make the Bid/Ask spread large. However, if market conditions are such that Bids and Asks are not being filled, the market maker may decide to reduce the spread. Similarly, if the market maker's Bids and Asks are being filled at an excessively high rate, the market maker may determine that its Bid/Ask spread should be increased. When a market maker determines that its Bid and/or Ask prices should be adjusted, the market maker must take the necessary action to cancel its resting Bid and/or Ask orders and submit new Bid/Ask orders at the adjusted price(s). Since market making is a fast moving business where small spreads are earned in very short periods of time, the current process for adjusting resting orders submitted according to a market making strategy is overly cumbersome and time consuming and can cause the market maker to miss advantageous buy and sell opportunities as well as situations where the market marker desires to adjust resting orders so as to avoid having orders resting at stale prices in fast moving markets.

What is needed, therefore, is a process that enables market makers to quickly and efficiently adjust one or more parameters of a market making strategy.

### SUMMARY OF THE INVENTION

The present invention achieves its objectives by providing a method and apparatus for adjusting one or more parameters of a strategy for making markets in a financial instrument traded on an electronic exchange. In accordance with the method, a market making strategy is implemented for a financial instrument traded on an electronic exchange. The market making strategy includes determining a target market value for the financial instrument to which the market making strategy is applied, and establishing one or more parameters of the strategy based at least in part on the determined target market value of the instrument. The established parameters include; (a) book depth for resting trade orders submitted to the electronic exchange in accordance with the market making strategy (Book Depth); (b) Bid/Ask spread (Aggression); and (c) Bid/Ask spread shift with no change to Aggression (Bias). At least one of the parameters of the implemented strategy are then adjusted.

Depending on the type and amount of parameter adjustment made, a variety of trade actions may result. For example, as a result of the adjustment, at least one new trade order may be submitted to the electronic exchange. Alternatively, or in addition to the submittal of new trade orders, at least one resting trade order submitted to the electronic exchange in accordance with the market making strategy may be canceled.

In one embodiment, the target market value is a discrete theoretical market value of the financial instrument. In another embodiment, the target market value is a range of theoretical market values of the financial instrument.

The parameters may be adjusted in a variety of ways. For example, Book Depth may be adjusted by submitting at least one resting trade order at a price level in which no trade orders submitted according to the strategy were resting prior to adjusting the Book Depth. Alternatively, Book Depth may be adjusted by canceling at least resting trade order. Aggression may be adjusted by increasing or decreasing the Bid/Ask spread, and Bias may be adjusted by shifting the Bid/Ask spread with no change to Aggression.

A graphical user interface is preferably employed to adjust the parameters of the resting trade orders.

Further to the above, the invention also provides an apparatus for adjusting one or more parameters of a strategy for making markets in a financial instrument traded on an electronic exchange. The apparatus includes an electronic trading platform for submitting trade orders for a financial instrument to the electronic exchange according to the market making strategy, and a parameter adjustment graphical user interface (GUI) with user controls configured to adjust one or more parameters of the market making strategy.

The parameter adjustment GUI may take, a variety of forms, but preferably includes a first area having a Book Depth adjustment control for adjusting Book Depth by a desired amount, a second area having an Aggression adjustment control for adjusting Aggression by a desired amount, and a third area having a Bias adjustment control for adjusting Bias by a desired amount.

A mapping GUI is also preferably provided for setting the level of parameter adjustment provided by the parameter adjustment GUI.

### BRIEF DESCRIPTION OF THE DRAWINGS

Preferred embodiments of the invention will now be described in further detail. Other features, aspects, and advantages of the present invention will become better understood with regard to the following detailed description, appended claims, and accompanying drawing (which are not to scale) where:

FIG. 1 is a functional block diagram of an apparatus for adjusting parameters of trade orders submitted to an electronic exchange for the purpose of making markets for a financial instrument according to the invention;

FIG. 2 is a screenshot of a parameter adjustment GUI according to the invention;

FIG. 3 is a screenshot of a mapping GUI for mapping the level of adjustment provided by the parameter adjustment GUI of FIG. 2; and

FIG. 4 is a flow diagram of a method for adjusting parameters of trade order submitted to an electronic exchange for the purpose of making markets for a financial instrument according to the invention.

### DETAILED DESCRIPTION OF THE PREFERRED EMBODIMENT

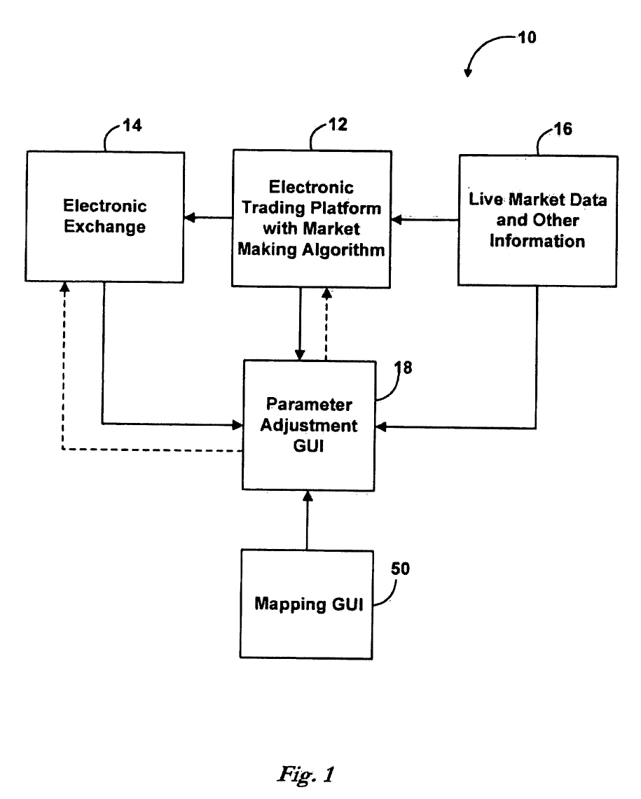

Turning now to the drawings wherein like reference characters indicate like or similar parts throughout FIG. 1 is a functional block diagram of an apparatus 10 for adjusting one or more parameters of a strategy for making markets in a financial instrument traded on an electronic exchange 14. The apparatus 10 includes an electronic trading platform 12 for submitting trade orders to the exchange 14 according to the market marking strategy. The trading platform 12 may be essentially any capable computer or other digital processing device configured to enable an electronic trader to make markets in a financial instrument by submitting paired Bids (buys) and Asks (sells) for the financial instrument. An example of a software program that can be loaded onto a computer to create a trading platform capable of making markets in a financial instrument is provided by GL Trade S.A. under the trade name GL Rubyx. Other such platforms are often developed internally by professional trading firms, including the software that enables the platform to perform market making activity.

Market making strategies can vary greatly, but typically involve an analysis of information and data (such as market data) to establish various parameters such as Book Depth (the number of price levels at which paired Bids and Asks will rest), Aggression (the Bid/Ask spread), and Bias (shifting the Bid/Ask spread along the price axis with no change to Aggression). Each of these parameters may in turn be based at least in part on a theoretical market value, or target market value, for the particular financial instrument that the market maker wishes to make markets in. Many market makers will employ strategies that make use of a market making algorithm, or strategy engine that is included as part of the trading platform 12. Such algorithms are usually proprietary in nature, but typically will entail an algorithm that determines a theoretical fair market value/target market value (which may be a discrete market value or a range of market values) based on input such as a live market data feed 16 and/or other information the market maker deems useful for strategizing how to make markets in a particular financial instrument, and as a result of the strategy, where to place trade orders for the instrument. By “financial instrument”, what is meant is any native or synthetic instrument that can be traded on an electronic exchange, including equities, commodities and fixed income.

It should be noted that market making strategies can produce a variety of results in terms of trade orders submitted to an exchange. For example, it is possible that a particular market making strategy will result in no trade orders being submitted and/or resting as a result of then existing market conditions. In such circumstances, the market maker may wish to adjust one or more parameters of the implemented market making strategy so as to actually submit paired Bid/Ask market making orders. It is also possible that a market making strategy could result in trade orders being submitted and immediately filled, in which case, the strategy would not maintain any resting (i.e., unfilled) orders. Under these conditions, the market maker may wish to adjust one or more parameters of the implemented strategy so as to have at least one Bid and at least one Ask resting on the book. However, implementation of a typical market making strategy will usually result in one or more Bid (buy) and one or more Ask (sell) orders resting at price levels dictated by the market making strategy set forth in any market making algorithm (or other strategy) that may be employed and the trade order parameters which characterize that strategy. And many strategies will look to produce a book of multiple Bid/Ask spreads resting at different price levels.

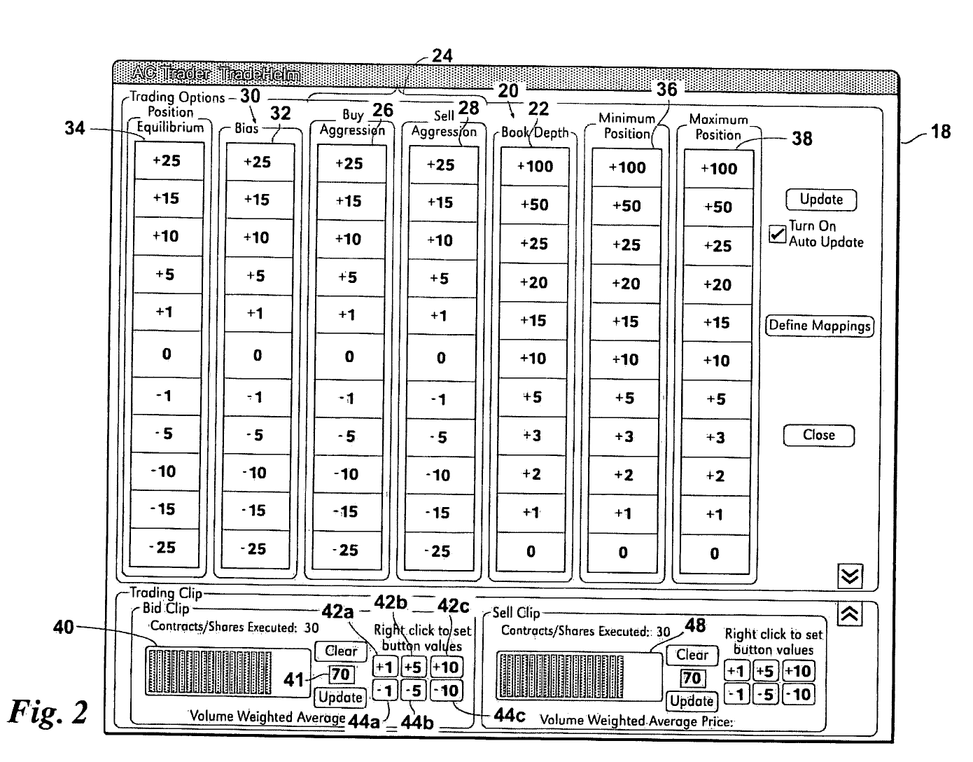

With further reference to FIG. 1, the apparatus 10 includes a parameter adjustment GUI (graphical user interface) 18 for adjusting one or more parameters of the implemented market making strategy. Parameter adjustment GUI 18 may take a variety of forms so long as it is configured to adjust one or more parameters of the market making strategy. FIG. 2 provides a screenshot of a preferred embodiment of a parameter adjustment GUI 18. GUI 18 includes various parameter adjustment controls for adjusting strategy parameters, including a Book Depth adjustment area 20 having a Book Depth adjustment control 22 for adjusting Book Depth, an Aggression adjustment area 24 having an Aggression adjustment control 26, 28 for adjusting Aggression, and a Bias adjustment area 30 having a Bias adjustment control 32 for adjusting Bias. Although a preferred embodiment of the parameter adjustment GUI 18 includes dual Aggression, adjustment controls—one for Bid (buy) Aggression and one for Ask (sell) Aggression—it will be understood that a single Aggression adjustment control may be employed for both Bids and Asks. However, the dual Aggression adjustment control configuration shown in FIG. 2 provides a greater level of control over the Aggression parameter and is therefore preferable.

In the embodiment shown in FIG. 2, each of the parameter adjustment controls 22, 26, 28, 32, 34, 36, 38 includes a plurality of discrete adjustment control areas, or “buttons” with numerical values that the market maker may activate (such as by a mouse click) to adjust the respective parameter. However, it will be understood that other forms of adjustment control may be employed instead, such as a graphical slider or graphical scroll wheel positioned in the various parameter adjustment areas 20, 24, 30.

To adjust Bias by a desired amount, the market maker may simply click on any of the discrete values, or “Bias buttons” shown on the Bias adjustment control 32 of FIG. 2. By clicking on the bias button labeled “+5”, Bias will be set to the predetermined amount of +5 ticks (i.e., Bias will shift the Bid/Ask spread to +5 tick increments from the determined theoretical fair market value). Similarly, clicking on any of the “−5” Bias button will set Bias to the predetermined amount of −5 tick increments. The amount by which a parameter such as Bias is increased or decreased may be either fixed or definable by the market maker. For the latter, each of the discrete Bias buttons for the Bias adjustment control 32, Aggression adjustment control 26, 28 and Book Depth adjustment control 20, as well as the other adjustment control areas for parameters such as Position Equilibrium 34, Minimum Position 36 and Maximum Position 38 shown in FIG. 2, may be defined by the market maker to provide a desired amount of adjustment to the respective parameter.

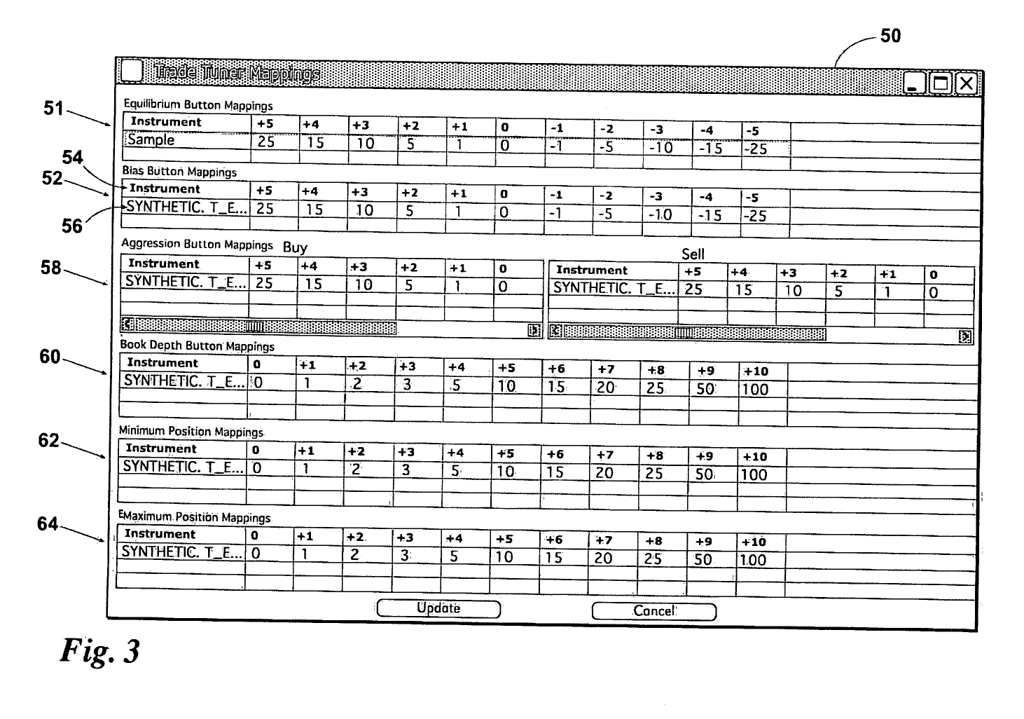

FIG. 3 is a screenshot of a mapping GUI 50 that may be employed to set, or map the level of parameter adjustment provided by the parameter adjustment GUI 18. Mapping GUI 50 includes mapping functionality for the Position Equilibrium, Bias, Aggression (Bid and Ask), Book Depth, Minimum Position, and Maximum position parameters. Parameter button mapping areas are provided in the mapping GUI 50, including a Position Equilibrium button mapping area 51, a Bias button mapping area 52, an Aggression button mapping area 58, a Book Depth button mapping area 60, a Minimum Position button mapping area 62, and a Maximum Position button mapping area 64. By way of illustration, only Bias button mapping area 52 will be described, it being understood that each of the other parameter button mapping areas 51, 58, 60, 62, 64 are similarly configured.

Bias button mapping area 52 includes two rows of numerical values. The top row is a button identification row 54 that uses a simple numbering scheme to provide a unique identifier for each of the Bias buttons in GUI 18. The bottom row is a button value row 56 that ascribes a predetermined value of Bias to each of the respective buttons identified in row 54. As shown, the Bias button labeled “0” in row 54 is set to zero Bias in row 56, and the Bias button labeled “+5” is set to a Bias of 25. These values are reflected in the respective Bias buttons shown in FIG. 2. If the market maker wishes to adjust the Bias values assigned to any of the Bias buttons, the market maker simply edits those values in the Bias button value row 56 through appropriate user interface inputs (such as through a keyboard and mouse).

The particular manner in which resting trade orders are adjusted at the exchange will depend on the order placement rules that have been promulgated by the particular exchange. For example, some exchanges support only trade orders submittals and trade order cancellations. To adjust resting trade orders at this type of exchange, the market maker must submit cancel orders for resting Bids and Asks that need to be canceled as a result of strategy parameter adjustment and submit any new Bids and/or Asks that the adjusted strategy dictates. Thus, multiple trade orders may need, to be submitted as a result of strategy adjustment. Other exchanges allow what is commonly referred to as a “CXR” order, or Cancel/Replace order. To adjust resting trade orders at this type of exchange, the market maker can place only one order to both cancel a resting Bid or Ask and replace it with a new one. Still other exchanges allow the market maker to submit a single order that will place both a Bid and an Ask to create a Bid/Ask spread. And there are exchanges that even allow so-called “mass quotation functionality” where one trade order may be submitted to place a plurality of Bid/Ask spreads. The invention described herein is compatible with the order placement rules of the exchanges, so for purposes of clarity, the term “trade order” as used herein shall refer to a single order or equivalent message that is sent to an exchange in accordance with the exchange's order placement rules.

In most instances where Book Depth is adjusted, the market maker submits at least one trade order at a price level in which no trade orders submitted according to the strategy were resting prior to adjusting the Book Depth. The submitted trade order may be an order to buy a specified quantity of the instrument at a new price level (i.e., a price level in which no Bids submitted according to the strategy are currently resting) and/or to sell a specified quantity of the instrument at a new price (i.e. a price level in which no Asks submitted according to the strategy are currently resting). Or the submitted trade order may be an order to cancel all Bids resting at one price level and/or to cancel all Asks resting at a different price level.

When Aggression is adjusted, the Bid/Ask spread is increased or decreased accordingly by submitting one or more appropriate trade orders to the exchange.

When Bias is adjusted, the Bid/Ask spread is shifted along the price axis for the instrument as the Bid/Ask spread remains constant (i.e., no change to Aggression) by submitting one or more appropriate trade orders to the exchange.

FIG. 2 also includes optional functionality for limiting the quantity of Bids and Asks that may be submitted. A Bid limit window 40 provides a graphic representing the quantity of Bids for the instrument that may be submitted before reaching the set limit. By setting a Bid quantity limit in window 40, the market maker's ability to avoid an undesired condition where orders for Bids are executed at an excessively high rate is enhanced.

In FIG. 2, the Bid quantity limit has been set to 100 and the information provided immediately above window 40 shows that 30 Bids have already been executed, which leaves a reserve of 70 (area 41) Bids that may be submitted before the 100 Bid limit is reached. As the quantity shown in window 40 decreases in an acceptable manner, the market maker can add quantity to window 40 by clicking on any of the Add Quantity buttons 44a, 44b, 44c. The market maker may also subtract quantity from window 40 by clicking on any of the Subtract Quantity buttons 46a, 46b, 46c. An Ask limit window 48 is also provided to enable the market maker to similarly limit the quantity of Asks that may be submitted.

Trade orders submitted to the exchange in response to strategy parameter adjustments may be submitted in a variety of ways. As indicated in FIG. 1, parameter adjustment GUI 18 may be configured to communicate with the electronic trading platform 12. In this configuration, parameter adjustments made at GUI 18 are provided to the trading platform 12, which in turns generates appropriate trade orders based on the adjusted parameters and submits those trade orders to the exchange. Alternatively, parameter adjustment GUI 18 is configured to receive a live market data feed 16 from the exchange or an external source so that GUI 18 can submit trade orders to the exchange. Or, with a modification to this latter configuration, GUI 18 may be configured to generate trade orders that are submitted to the exchange by trading platform 12.

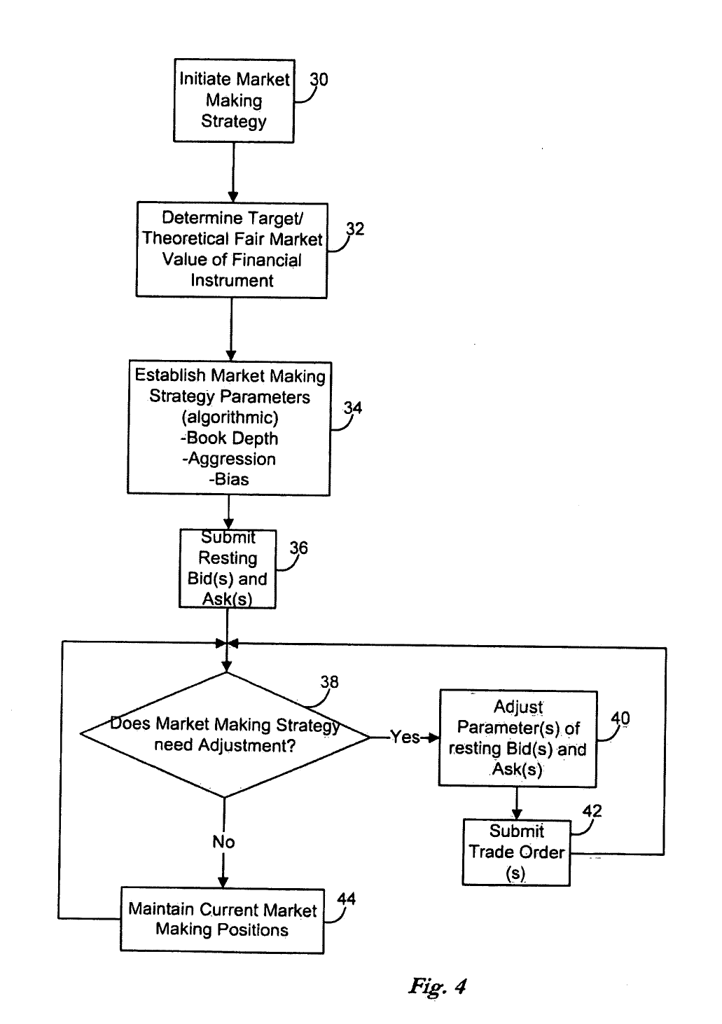

FIG. 4 provides a functional flow diagram for a method for adjusting one or more parameters of a market making strategy as described herein. In accordance with the method, a market making strategy is initiated 30 and a target/theoretical fair market value of a financial instrument is determined 32. Market making strategy parameters are established 34. The strategy parameters will preferably include Book Depth, Aggression and Bias. Resting Bids and Asks are, in many cases, submitted to an electronic exchange 36. As the Bids and Asks are resting, the market maker determines whether his strategy needs adjustment 38. If so, the appropriate parameters are adjusted 40 by way of the parameter adjustment GUI 18, and one or more trade orders are submitted as a result of the adjusted parameters 42. If the market making strategy does not need to be adjusted, the current market position is maintained 44.

The foregoing description details certain preferred embodiments of the present invention and describes the best mode contemplated. It will be appreciated, however, that changes may be made in the details of construction and the configuration of components without departing from the spirit and scope of the disclosure. Therefore, the description provided herein is to be considered exemplary, rather than limiting, and the true scope of the invention is that defined by the following claims and the full range of equivalency to which each element thereof is entitled.

What is claimed is:

1. A method for adjusting one or more parameters of a strategy for making markets in a financial instrument traded on an electronic exchange, the method comprising:
implementing a market making strategy for a financial instrument traded on an electronic exchange, said market making strategy including:
determining a target market value for the financial instrument to which the market making strategy is applied; and
establishing one or more parameters of the strategy based at least in part on the determined target market value of the instrument, said one or more parameters selected from the group consisting of: (a) book depth for resting trade orders submitted to the electronic exchange in accordance with the market making strategy (Book Depth); (b) Bid/Ask spread (Aggression); and (c) Bid/Ask spread shift with no change to Aggression (Bias); and
adjusting at least one of said one or more parameters of the implemented strategy.

2. The method of claim 1 wherein as a result of said adjusting step, at least one new trade order is submitted to the electronic exchange.

3. The method of claim 1 wherein as a result of said adjusting step, at least one resting trade order submitted to the electronic exchange in accordance with the market making strategy is canceled.

4. The method of claim 1 wherein the target market value is a discrete theoretical market value of the instrument.

5. The method of claim 1 wherein the target market value is a range of theoretical market values of the instrument.

6. The method of claim 1 wherein Book Depth is adjusted by submitting at least one resting trade order at a price level in which no trade orders submitted according to the strategy were resting prior to adjusting the Book Depth.

7. The method of claim 1 wherein Book Depth is adjusted by canceling at least one resting trade order.

8. The method of claim 1 wherein Aggression is adjusted by increasing or decreasing the Bid/Ask spread.

9. The method of claim 1 wherein Bias is adjusted by shifting the Bid/Ask spread with no change to Aggression.

10. The method of claim 1 wherein said adjusting step further includes:
providing a graphical user interface with user controls configured to adjust said one or more parameters of the strategy; and
adjusting said one or more parameters of the implemented strategy through user input of the graphical user interface.

11. A method for adjusting one or more parameters of a strategy for making markets in a financial instrument traded on an electronic exchange, the method comprising:
implementing a market making strategy for a financial instrument traded on an electronic exchange, said market making strategy including:
determining a target market value for the financial instrument to which the market making strategy is applied; and
establishing one or more parameters of the strategy based at least in part on the determined target market value of the instrument, said one or more parameters included in the group consisting of: (a) book depth for resting Bids and Asks submitted to the electronic exchange in accordance with the market making strategy (Book Depth); (b) Bid/Ask spread (Aggression); and (c) Bid/Ask spread shift with no change to Aggression (Bias);
providing a graphical user interface with user controls configured to adjust said one or more parameters of the strategy; and
adjusting said one or more parameters of the implemented strategy through user input of the graphical user interface.

12. The method of claim 11 wherein said graphical user interface includes:
a first area having a Book Depth adjustment control for adjusting Book Depth by a desired amount:
a second area having an Aggression adjustment control for adjusting Aggression by a desired amount; and
a third area having a Bias adjustment control for adjusting Bias by a desired amount.

13. The method of claim 12 wherein each of said adjustment controls includes a plurality of discrete adjustment control areas for adjusting a parameter of the strategy by a predetermined amount.

14. The method of claim 13, further comprising the step of changing the amount of adjustment provided by each of said plurality of discrete adjustment control areas.

15. The method of claim 11 wherein the target market value is a discrete theoretical market value of the instrument.

16. The method of claim 11 wherein the target market value is a range of theoretical market values of the instrument.

17. The method of claim 11 wherein Book Depth is adjusted by submitting at least one resting trade order at a price level in which no trade orders submitted according to the strategy were resting prior to adjusting the Book Depth.

18. The method of claim 11 wherein Book Depth is adjusted by canceling at least one resting trade order.

19. The method of claim 11 wherein Aggression is adjusted by increasing or decreasing the Bid/Ask spread.

20. The method of claim 11 wherein Bias is adjusted by shifting the Bid/Ask spread with no change to Aggression.

21. An apparatus for adjusting one or more parameters of a strategy for making markets in a financial instrument traded on an electronic exchange, the apparatus comprising:
an electronic trading platform for submitting trade orders for a financial instrument to an electronic exchange according to a market making strategy; and
a parameter adjustment graphical user interface (GUI) with user controls configured to adjust one or more parameters of the market making strategy.

22. The apparatus of claim 21 wherein said parameter adjustment GUI includes a first area having a Book Depth adjustment control for adjusting Book Depth by a desired amount.

23. The apparatus of claim 21 wherein said parameter adjustment GUI includes a second area having an Aggression adjustment control for adjusting Aggression by a desired amount.

24. The apparatus of claim 21 wherein said parameter adjustment GUI includes a third area having a Bias adjustment control for adjusting Bias by a desired amount.

25. The apparatus of claim 21, further comprising a mapping GUI for setting the level of parameter adjustment provided by the parameter adjustment GUI.

26. An apparatus for adjusting one or more parameters of a strategy for making markets in a financial instrument traded on an electronic exchange the apparatus comprising:
an electronic trading platform for submitting trade orders to an electronic exchange according to a market making strategy; and
a parameter adjustment graphical user interface (GUI) with user controls configured to adjust one or more parameters of the market making strategy, said parameter adjustment GUI having:
a first area having a Book Depth adjustment control for adjusting Book Depth by a desired amount;
a second area having an Aggression adjustment control for adjusting Aggression by a desired amount; and
a third area having a Bias adjustment control for adjusting Bias by a desired amount.

27. The apparatus of claim 26, further comprising a mapping GUI for setting the level of parameter adjustment provided by the parameter adjustment GUI.
